(19) United States
(12) Patent Application Publication
(10) Pub. No.: US 2024/0278371 A1
(43) Pub. Date: Aug. 22, 2024

(54) Accessory for a Hand-Held Power Tool and Power Tool System Comprising a Hand-Held Power Tool and Such an Accessory

(71) Applicant: Robert Bosch GmbH, Stuttgart (DE)

(72) Inventors: Andre Ullrich, Leinfelden-Echterdingen (DE); Holger Froehling, Stuttgart (DE)

(21) Appl. No.: 18/439,483

(22) Filed: Feb. 12, 2024

(30) Foreign Application Priority Data
Feb. 16, 2023 (DE) 10 2023 201 334.7

(51) Int. Cl. B23Q 11/00

(52) U.S. Cl. CPC B23Q 11/0046

(57) ABSTRACT

An accessory, in particular a suction device, for fixing to a hand-held power tool, on which a battery pack can be arranged for supplying power to a drive motor, includes a battery protection element designed to enclose the battery pack arranged on the hand-held power tool at least in sections and to protect the battery pack in the event of impact pulses occurring.

This application claims priority under 35 U.S.C. § 119 to application no. DE 10 2023 201 334.7, filed on Feb. 16, 2023 in Germany, the disclosure of which is incorporated herein by reference in its entirety.

### BACKGROUND

The present disclosure relates to an accessory, in particular a suction device, for attachment to a hand-held power tool, on which a battery pack can be arranged to supply power to a drive motor.

An accessory designed as a suction device for a hand-held power tool is known from the prior art. The suction device can be detachably arranged on the hand-held power tool.

### SUMMARY

The disclosure relates to an accessory, in particular a suction device, for attachment to a hand-held power tool, on which a battery pack can be arranged to supply power to a drive motor. A battery protection element is provided, which is designed to enclose the battery pack arranged on the hand-held power tool at least in sections and to protect it in the event of impact pulses occurring.

The disclosed arrangement thus makes it possible to provide an accessory for a hand-held power tool, in which the battery protection element can provide efficient protection of a battery pack arranged on the hand-held power tool in the event of impact pulses occurring. This means that damage to or destruction of the battery pack by such impact pulses can be, at least largely, prevented.

Preferably, a base body is provided which is designed integrally with the battery protection element.

This makes it easy to provide a suitable battery protection element.

According to one embodiment, the battery protection element is made of plastic.

This means that a robust and cost-effective battery protection element can be provided.

Preferably, the battery protection element forms a trough-shaped receptacle for receiving the battery pack arranged on the hand-held power tool.

This means that the battery pack can be easily and simply enclosed and thus protected in the event of an impact pulse.

According to one embodiment, the battery protection element is designed as a dust collection container.

This means that the battery protection element can be efficiently integrated into a functional element.

According to a further embodiment, the battery protection element forms a plate-shaped protective body.

This makes it easy and uncomplicated to simplify the design of the battery protection element.

Preferably, a base body is provided which is connected to the battery protection element via a detachable connection, in particular a clamp connection or a screw connection.

This enables a safe and reliable arrangement of the battery protection element on the base body.

Preferably, the base body has a first material and the battery protection element has a second material, wherein the two materials are preferably different.

This makes it possible to create a robust and stable battery protection element for the accessory at low cost.

The present disclosure also relates to a power tool system with a hand-held power tool which has a drive motor and on which a battery pack for supplying power to the drive motor can be arranged, and with an accessory described above, in particular a suction device.

The disclosed arrangement thus makes it possible to provide a power tool system with a hand-held power tool and an accessory, in which the battery protection element can provide efficient protection of a battery pack arranged on the hand-held power tool in the event of impact pulses occurring. This means that damage to or destruction of the battery pack by such impact pulses can be, at least largely, prevented.

The battery protection element preferably comprises a side wall that covers the battery pack arranged on the hand-held power tool along its longitudinal extension on at least one battery side wall.

This is a simple way of configuring the battery protection element.

Preferably, the battery protection element has a bottom surface that covers the underside of the battery pack arranged on the hand-held power tool.

This means that the battery protection element can be easily and simply designed to protect the battery pack from impact pulses that can act on the battery pack from different directions.

According to one embodiment, the battery protection element forms a trough-shaped receptacle for receiving the battery pack arranged on the hand-held power tool.

This means that a simple and reliable battery protection element can be provided.

The battery protection element is preferably designed as a dust collection container.

This means that the battery protection element can be efficiently integrated into a functional element.

Preferably, the battery protection element is designed for use with battery packs with predefined battery pack dimensions.

This means that the battery protection element can be specifically adapted to the battery pack used.

The hand-held power tool is preferably designed as an impact/drilling machine or hammer drill.

This means that the accessory can be used advantageously with different hand-held power tools.

### BRIEF DESCRIPTION OF THE DRAWINGS

The disclosure is explained in further detail in the following description with reference to exemplary embodiments shown in the drawings. The figures show:

FIG. 1 a side view of a power tool system with a hand-held power tool and an accessory according to the disclosure with a battery protection element,

FIG. 2 a side view of the power tool system of FIG. 1 with a further battery protection element,

FIG. 3 a side view of the power tool system of FIG. 1 and FIG. 2 with a further battery protection element,

FIG. 4 a rear side of the power tool system of FIG. 1,

FIG. 5 a rear side of the power tool system of FIG. 2, and

FIG. 6 a rear side of the power tool system with a further battery protection element.

### DETAILED DESCRIPTION

Elements having the same or a comparable function are provided with the same reference characters in the drawings and are described in detail only once.

FIG. 1 shows an exemplary hand-held power tool 100, which illustratively has a housing 110 with a handle 115. According to one embodiment, the hand-held power tool 100 can be mechanically and electrically connected to a battery pack 190 for mains-independent power supply. For example, the battery pack 190 is locked to the handle 115.

Preferably, a tool receptacle 140 for receiving an insert tool, e.g. a screwdriver bit, a drill, etc., is associated with the hand-held power tool 100. Illustratively, the hand-held power tool 100 is designed as a hammer drill, but can alternatively also be designed as an impact/drilling machine, for example.

Illustratively, an electric drive motor 120 is arranged in the housing 110 for driving the tool receptacle 140 and thus an insert tool arranged therein. Here, the drive motor 120 can preferably be switched on and off via a manual switch 117.

In addition, an accessory 150 is illustratively detachably arranged on the hand-held power tool 100. As an example, the accessory 150 is designed as a suction device.

Preferably, the accessory 150 is mechanically and electrically connectable and illustratively connected to the hand-held power tool 100. Alternatively, the accessory 150 can also have its own power supply, e.g. a battery pack. It should be noted that the present disclosure is not limited to an accessory designed as a suction device. Rather, the accessory can also be designed, for example, as a light source or work area lighting, a measuring device for locating and/or leveling or as an additional handle.

The suction device 150 preferably has a base body 157 with a suction nozzle 152. During operation of the suction device 150, the suction nozzle 152 can be arranged on a surface of a workpiece to be processed. When the workpiece is being processed, dust and dirt particles are removed via the suction nozzle 152. The suction nozzle 152 can preferably be arranged around an insert tool during operation of the hand-held power tool 100. Furthermore, the suction nozzle 152 is preferably arranged on the base body 157 so as to be displaceable via a telescopic section 158. In addition, the suction device 150 illustratively has a dust collection container 156.

According to the disclosure, the accessory 150, in particular the suction device, has a battery protection element 155. The battery protection element 155 is preferably designed to enclose the battery pack 190 arranged on the hand-held power tool 100 at least in sections and to protect it in the event of impact pulses occurring, for example in the event of the hand-held power tool 100 accidentally falling down. Illustratively, the hand-held power tool 100 with the suction device 150 forms a power tool system 180.

According to one embodiment, the battery protection element 155 is designed integrally with the base body 157. Alternatively, the base body 157 is connected to the battery protection element 155 via a detachable connection, in particular a clamp or screw connection. Preferably, the battery protection element 155 is made of plastic.

According to a further embodiment, the base body 157 has a first material and the battery protection element 155 has a second material. The two materials are preferably different, but can also be identical. The two materials can be plastics with different properties. For example, the second material can be deformable and/or have damping properties.

Alternatively, the battery protection element 155 can be designed as a steel bracket, which can preferably be detachably connected to the accessory 150, in particular the suction device. The detachable connection is preferably a click and/or snap-in connection.

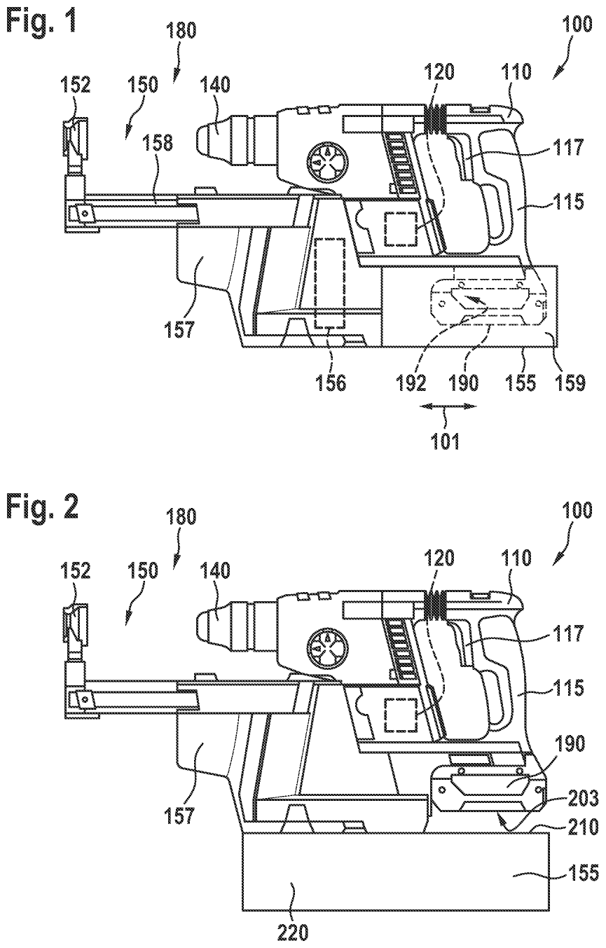

Preferably, the battery protection element 155 has a side wall 159 (612 in FIG. 6), which covers the battery pack 190 arranged on the hand-held power tool 100 along its longitudinal extension 101 on at least one battery side wall 192. In this case, the battery protection element 155 can form a receptacle (210 in FIG. 2 through FIG. 6) for receiving the battery pack 190. Preferably, the battery protection element 155 is designed for use with battery packs with predetermined battery pack dimensions.

FIG. 2 shows the power tool system 180 of FIG. 1 with the hand-held power tool 100 and the accessory 150, which is exemplarily designed as a suction device. According to one embodiment, the battery protection element 150 is designed as a dust collection container 220.

Here, the battery protection element 150 is illustratively designed to enclose the battery pack 190 on its underside 203 facing away from the hand-held power tool 100 and to protect it in the event of impact pulses occurring. Preferably, the dust collection container 220 has an L-shape.

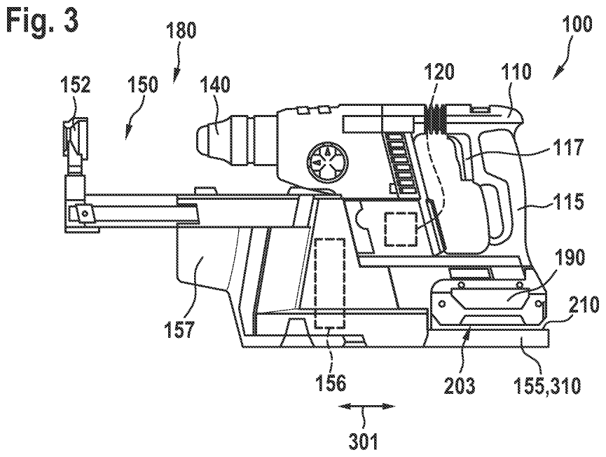

FIG. 3 shows the power tool system 180 of FIG. 1 and FIG. 2 with the hand-held power tool 100 and the accessory 150, exemplarily designed as a suction device. Illustratively, the battery protection element 155 has a bottom surface 310 that covers the battery pack 190 on its underside 203.

The battery protection element 155 preferably forms a plate-shaped protective body 310. The plate-shaped protective body 310 is designed as an extension of the accessory 150 in the longitudinal direction 301 such that the battery pack 190 is protected from impact pulses occurring at least on its underside 203.

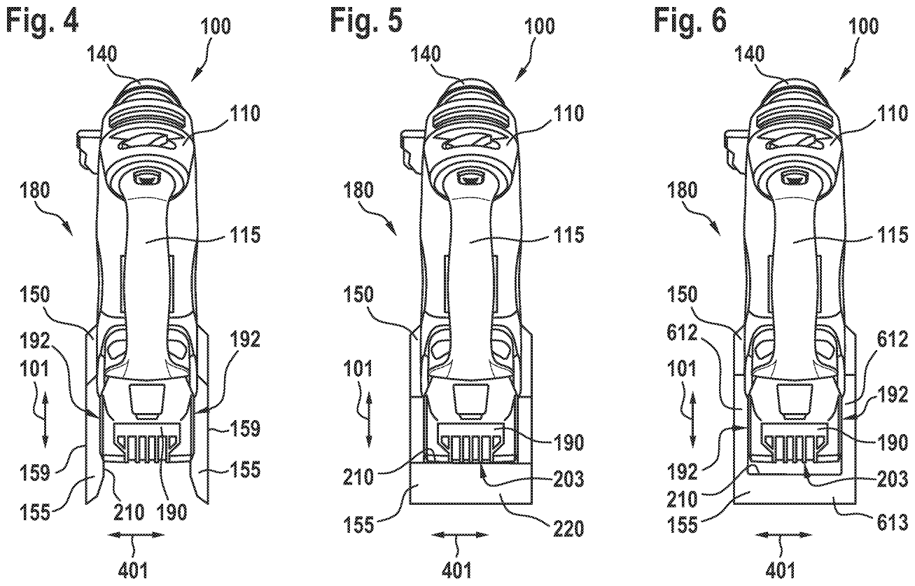

FIG. 4 shows the power tool system 180 of FIG. 1 with the battery protection element 155, which illustratively has two opposing side walls 159 arranged in a transverse direction 401 of the hand-held power tool 100 or the accessory 150. The receptacle 210 for receiving the battery pack 190 is designed between the two side walls 159. Here, at least the battery side walls 192 of the battery pack 190 arranged in the transverse direction 401 are protected by the side walls 159 of the battery protection element 155.

FIG. 5 shows the power tool system 180 of FIG. 2 with the battery protection element 155 in the form of a dust collection container 220, which protects an underside 203 of the battery pack 190.

FIG. 6 shows the power tool system 180 of FIG. 1 through FIG. 5 with the hand-held power tool 100 and the accessory 150, exemplarily designed as a suction device. Illustratively, the receptacle 210 for receiving the battery pack 190 is trough-shaped. Here, the battery protection element 155 preferably has two opposing side walls 612 protecting the battery side walls 192 of the battery pack 190 and a bottom surface 613 for protecting the underside 203 of the battery pack 190.

1. An accessory configured to fix to a hand-held power tool, on which a battery pack is arranged so as to supply power to a drive motor, the accessory comprising:
a battery protection element configured to enclose the battery pack arranged on the hand-held power tool at least in sections and to protect the battery in the event of impact pulses occurring.

2. The accessory according to claim 1, further comprising:
a base body configured integrally with the battery protection element.

3. The accessory according to claim 1, wherein the battery protection element comprises plastic.

4. The accessory according to claim 1, wherein the battery protection element forms a trough-shaped receptacle configured to receive the battery pack arranged on the hand-held power tool.

5. The accessory according to claim 1, wherein the battery protection element is configured as a dust collection container.

6. The accessory according to claim 1, wherein the battery protection element forms a plate-shaped protective body.

7. The accessory according to claim 1, further comprising:
a base body connected to the battery protection element via a detachable connection.

8. The accessory according to claim 7, wherein the base body comprises a first material and the battery protection element comprises a second material that is different from the first material.

9. A power tool system comprising:
a hand-held power tool having a drive motor and on which a battery pack for supplying power to the drive motor is arranged; and
an accessory comprising a battery protection element configured to enclose the battery pack arranged on the hand-held power tool at least in sections and to protect the battery in the event of impact pulses occurring.

10. The power tool system according to claim 9, wherein the battery protection element has a side wall that covers the battery pack along a longitudinal extension of the battery pack on at least one battery side wall.

11. The power tool system according to claim 9, wherein the battery protection element has a bottom surface which covers the battery pack on an underside of the battery pack.

12. The power tool system according to claim 9, wherein the battery protection element forms a trough-shaped receptacle configured to receive the battery pack.

13. The power tool system according to claim 11, wherein the battery protection element is configured as a dust collection container.

14. The power tool system according to claim 12, wherein the battery protection element is configured for use with battery packs having predetermined battery pack dimensions.

15. The power tool system according to claim 9, wherein the hand-held power tool is an impact/drilling machine or hammer drill.

16. The accessory according to claim 1, wherein the accessory is a suction device.

17. The accessory according to claim 7, wherein the detachable connection is a clamping or screw connection.

18. The power tool according to claim 9, wherein the accessory is a suction device.
